(19) United States
(12) Patent Application Publication
(10) Pub. No.: US 2014/0234455 A1
(43) Pub. Date: Aug. 21, 2014

(54) ANTIMICROBIAL COMPOSITION, METHOD FOR ITS PREPARATION AND ITS USE

(71) Applicant: PATOLAB OY, Espoo (FI)

(72) Inventor: Pentti Sipponen, Espoo (FI)

(21) Appl. No.: 14/348,192

(22) PCT Filed: Oct. 24, 2012
(86) PCT No.: PCT/FI2012/051019

§ 371 Date: Mar. 28, 2014

(30) Foreign Application Priority Data
Oct. 26, 2011 (FI) 20110371
Aug. 29, 2012 (FI) 20120287

(51) Int. Cl. A01N 37/36; A01N 37/10

(52) U.S. Cl. CPC A01N 37/36; A01N 37/10
USPC 424/770; 514/569

(57) ABSTRACT

An aqueous antimicrobial composition including coniferous resin acids a dispersing agent and an aqueous medium, a method for its preparation and its use as an antimicrobial agent in medical and non-medical field are provided.

### FIELD OF THE INVENTION

The present invention relates to an aqueous antimicrobial composition comprising coniferous resin acids, a method for its preparation and its use as an antimicrobial agent in medical and non-medical field.

### BACKGROUND OF THE INVENTION

Coniferous resin, typically of pine or spruce origin, has been widely used in naturopathy and traditional medicine for healing of skin wounds and skin infections. In this practice, the resin was typically cooked into animal fat.

Coniferous resin is a mixture of various chemical compounds, mainly composed of resin acids, lignans, fatty acids and volatile terpenic compounds. In addition to the term ‘resin’, such terms as ‘rosin’, ‘rosin gum’ or ‘colophonium’ are widely used as synonyms for the resin naturally present in coniferous trees.

The antimicrobial characteristics, such as antifungal and antibacterial characteristics, and even antiviral characteristics of coniferous resin are widely described in the literature. It has been shown that particularly the resin acids of the resin have antimicrobial potentials. For example, coniferous resin has broad-spectrum antimicrobial characteristics against pathogenic gram-positive and gram-negative bacteria. Indeed, there are fat-based resin salves on the market that are effective in the treatment of skin wounds and fungal nail infections. These salves are prepared by dissolving resin to ethanol.

WO 2011/042613 A2 describes an antimicrobial composition comprising coniferous resin acids and/or their derivates in alcohol solutions.

The coniferous resin, and particularly resin acids contained therein, is poorly soluble in water. An extensive use of the coniferous resin as an antimicrobial agent in a wide variety of materials and products is not possible until an aqueous solution of resin can be provided.

### BRIEF DESCRIPTION OF THE INVENTION

We have now found that a stable, uniformly distributed aqueous solution of coniferous resin can be prepared by means of a dispersing agent. We have surprisingly found that such an aqueous solution exhibit antimicrobial characteristic even with minor amounts of coniferous resin acids. The aqueous solution of the resin acids can be beneficially introduced to other aqueous compositions used in the treatment of a mammal, such as in pharmaceutical formulations, saline solutions, sugar solutions, aqueous infusion and injections solutions, rinsing solutions, clysma, water-dilutable salves, lotions, and cosmetic products, and to other products used in non-medical field, without losing an antimicrobial effect thereof.

An object of the present invention is to provide an aqueous antimicrobial composition comprising coniferous resin acids, a dispersing agent and an aqueous medium.

Another object of the invention is to provide a method of producing an aqueous antimicrobial composition comprising coniferous resin acids, comprising the steps of:
providing coniferous resin acids,
dissolving the resin acids in a dispersing agent to provide a mixture,
diluting the mixture with an aqueous medium to provide an aqueous antimicrobial composition.

The antimicrobial composition of the invention can be used as an antimicrobial agent as such or as an additive in formulations used in human medicine and veterinary medicine. The formulations can contain the composition of the invention in therapeutically effective amounts or in amounts suitable for preservative purposes. The antimicrobial composition of the invention can also be used in industrial materials and products as well as in foodstuffs.

A further object of the invention is to provide an aqueous antimicrobial composition of the invention for use as an antimicrobial agent as such or as an additive in pharmaceutical formulations and products applied in human and/or veterinary medicines.

A still further object of the invention is to provide a pharmaceutical formulation comprising an aqueous antimicrobial composition of the invention and pharmaceutically acceptable diluent, carrier and/or excipient.

A still further object of the invention is to provide a use of an aqueous antimicrobial composition of the invention as an antimicrobial agent as such or as an additive in pharmaceutical formulations and products in human and/or veterinary medicines.

A still further object of the invention is to provide a use of an aqueous antimicrobial composition of the invention as such or as an additive for treating inflammation and/or infection in a mammal.

A still further object of the invention is to provide a use of an aqueous antimicrobial composition of the invention in the manufacture of a medicament for treating inflammation and/or infection in a mammal.

A still further object of the invention is to provide an aqueous antimicrobial composition of the invention for use in treating inflammation and/or infection in a mammal.

A still further object of the invention is to provide a method of treating inflammation and/or infection in a mammal, comprising administering a therapeutically effective amount of an aqueous antimicrobial composition of the invention.

A still further object of the invention is to provide a use of an aqueous antimicrobial composition of the invention as an antimicrobial agent in industrial materials and products, and in foodstuffs.

### BRIEF DESCRIPTION OF THE DRAWINGS

FIGS. 1A and 1B show the antimicrobial effect of the aqueous antimicrobial compositions of the invention against Staphylococcus aureus in the agar diffusion plate test.

FIG. 2 shows the antimicrobial effect of the aqueous antimicrobial compositions of the invention against Helicobacter pylori in Brucella agar plate.

### DETAILED DESCRIPTION OF THE INVENTION

An object of the present invention is to provide an aqueous antimicrobial composition comprising coniferous resin acids, a dispersing agent and an aqueous medium. The composition is stable, evenly dispersible to and dilutable with an aqueous medium.

The content of the coniferous resin of the aqueous antimicrobial composition of the invention is in the range of about 1 to about 100 ppm. In an embodiment, the content is about 1 to about 50 ppm. In another embodiment, the content is about 1 to about 10 ppm.

In an embodiment, the coniferous resin acids are selected from a group consisting of dehydroabietic acid, 7β-hydroxydehydroabietic acid, 7α-hydroxydehydroabietic acid, 15-hydroxydehydroabietic acid, 7β8,15dihydroxydehydroabietic acid, 7α,15-dihydroxydehydroabietic acid, 18-hydroxydehydroabietic acid, further hydroxylated derivates of dehydroabietic acid and a mixture thereof.

In an embodiment, the coniferous resin acids are provided as purified “callus” resin of coniferous trees. In another embodiment, the coniferous resin acids are provided as a resin acid fraction of tall oil obtained from kraft pulping of coniferous trees. The coniferous resin acids can be provided as a solution or in powdery or granulated form.

The dispersing agent is selected from a group consisting of polyhydric alicyclic alcohol, polyhydric aliphatic alcohol, dimethyl sulfoxide, acetone, protein-containing aqueous liquid, sugar-containing aqueous liquid, serum, plasma, liquids used in cell and tissue cultures, such as agar, serum, artificial culture media, and a mixture thereof. In the context of the present invention, the term “polyhydric alcohol” means an alcohol having two or more hydroxyl groups in the molecule. In an embodiment, the polyhydric aliphatic alcohol is selected from a group consisting of glycerol, monopropylene glycol, xylitol, mannitol and sorbitol. In an embodiment of the invention, the dispersing agent is glycerol.

The aqueous medium can be any suitable aqueous solution. In an embodiment, the aqueous medium is a physiological saline solution. The physiological saline solution is preferred, when the antimicrobial composition is used in applications in fields of human and veterinary medicines. In another embodiment, the aqueous medium is water.

The antimicrobial effect of the composition of the invention can be adjusted by diluting the composition with the aqueous medium.

The composition of the invention is free of highly volatile organic compounds, such as ethanol.

In an aspect, the invention provides a method for producing an aqueous antimicrobial composition of the invention, comprising the steps of:
providing coniferous resin acids,
dissolving the resin acids in a dispersing agent to provide a mixture,
diluting the mixture with an aqueous medium to provide an aqueous antimicrobial composition.

The dispersing agent can contain an amount of an aqueous medium as long as the dispersing ability of the agent is still maintained. In an embodiment, the dispersing agent contains up to about 50% of an aqueous medium. In an embodiment, the dispersing agent contains up to about 30% of an aqueous medium.

If desired, the resin acids can be extracted in volatile carrier substance, such as ethanol, prior to blending with the dispersing agent. The volatile substance is evaporated from the composition before further use of the composition. Heating can be used to enhance the evaporation.

If desired, the dissolution is performed under stirring and/or heating to enhance the dissolution of the resin acids.

During dilution of the mixture of the resin acids and the dispersing agent with the aqueous medium, a deposit of insoluble resin is formed. The deposit is removed, if necessary, for example by filtration. Finally, an evenly distributed and stable colloidal dispersion is obtained. This dispersion can be further diluted with aqueous solution without formation of any precipitations or deposits.

A wide range of various bacteria, such as Helicobacter pylori, can cause stomach infections (chronic gastritis) that can be treated with the antimicrobial compositions of the invention. Chronic gastritis in stomach mucosa is the fundamental reason for the most important gastric disorders, such as stomach cancer or peptic ulcer, atrophic gastritis and hypochlorhydric stomach. It is widely known that the treatment against Helicobacter pylori is problematic which often requires several re-treatments attempts and many antibiotics. Helicobacter pylori infections are typically treated also with colloidal bismuth compositions that topically (intragastrically) kill bacteria that grow and multiplicate on the stomach mucosa surface.

The aqueous antimicrobial composition of the invention can be used as such as an aqueous solution or it can be formulated to appropriate pharmaceutical water-dilutable formulations suitable for the treatment of mammalian inflammation and/or infection. The formulations can contain further ingredients typically used in pharmaceutical formulations, such as excipients, fillers, flavourings, etc.

The pharmaceutical product can be for example a bandage, dressing, plaster, tissue towel, etc.

The composition of the invention can be used, for example, in medical field as follows:
as an antimicrobial therapeutic agent (tablets, capsules, infusion and injections liquids, salves, drops, gels, suppositorium, etc.)
as an intravenous or intra-arterial infusion for the treatment of septicaemia
as an antimicrobial fluid to be injected into tissues, joint, cavities, tissues or abscesses
as an antimicrobial solution for washing of tissue cavities (oral cavity, maxillary sinus, ear canal, abdominal cavity, pleural cavity, urinary bladder and urinary tract or vagina, fistulae, fissures, or ducts, etc.)
as an antimicrobial composition in treatment of skin ulcers, sores, burns, or infections
as an antimicrobial additive in bandages, dressings, tissue towels or products used in treatment of skin ulcers, sores, burns or infections
as an antimicrobial composition for fungal nail or skin infections
as eye drop, eye salve or eye washing solution
as mouthwash
as a vagitorium, salve, cream or solution in treatment of gynecological infections or diseases (bacterial and fungal infections)
as an additive in water-dilutable salves, creams, solutions, lotions, gels, sprays, soaps or medicaments used in treatment, disinfection or washing of skin, skin wounds, skin lesions or infections
as an antimicrobial additive in cosmetic or hygiene products, tissue papers, soaps or shampoos
as an antimicrobial additive for preservation of medicines
as an antimicrobial agent in the treatment of outer surfaces of a mammal, such as skin, hair, feet hoofs and udders
as an antimicrobial additive in the washing and protection of outer surfaces of a mammal, such as skin, hair, feet hoofs and udders.

A further object of the invention is to provide an aqueous antimicrobial composition of the invention for use as an antimicrobial agent as such or as an additive in pharmaceutical formulations and products applied in human and/or veterinary medicines.

A still further object of the invention is to provide a pharmaceutical formulation comprising an aqueous antimicrobial composition of the invention and pharmaceutically acceptable diluent, carrier and/or excipient.

A still further object of the invention is to provide a use of an aqueous antimicrobial composition of the invention as an antimicrobial agent as such or as an additive in pharmaceutical formulations and products in human and/or veterinary medicines.

A still further object of the invention is to provide a use of an aqueous antimicrobial composition of the invention as such or as an additive for treating inflammation and/or infection in a mammal.

A still further object of the invention is to provide a use of an aqueous antimicrobial composition of the invention in the manufacture of a medicament for treating inflammation and/or infection in a mammal.

A still further object of the invention is to provide an aqueous antimicrobial composition of the invention for use in treating inflammation and/or infection in a mammal.

A still further object of the invention is to provide a method of treating inflammation and/or infection in a mammal, comprising administering a therapeutically effective amount of an aqueous antimicrobial composition of the invention.

The composition of the invention can be absorbed to a solid carrier, such as gelatin, cellulose, starch. etc. If desired, the amount of the resin acids in the carrier can be increased to amounts higher than 100 ppm by evaporation the aqueous component of the composition, e.g., by heating or warming.

The composition of the invention can be diluted to a desired concentration with a pharmaceutical carrier, such as salve base or aqueous solution, to provide a pharmaceutical formulation. In an embodiment, the composition of the invention is combined with an aqueous ointment/salve base to provide an eye ointment or salve. The content of the coniferous resin in the eye salve or drops is typically in the range of about 1 to about 30 ppm.

The aqueous antimicrobial composition or formulations of the invention containing said composition can contain one or more pharmaceutically active agent, such as hydrocortisone, cortisone, glucosamine and dexpanthenol.

The composition or the formulation of the invention can be administered orally, intravenously, intra-arterially, subcutaneously, intramuscularly, topically, as an injection or as an infusion.

A further object of the invention is to provide an aqueous antimicrobial composition of the invention for use as an antimicrobial agent in non-medical field, such as in industrial materials and products as well as in foodstuffs. In non-medical purposes, the composition of the invention can be used as follows:
as an antimicrobial additive in paints, lacquers, varnish, wax, or various other cover materials
as an antimicrobial composition for protection of paper, paperboard, cardboard, leather, textile, cloth, fur, glass, metal, rubber, wood or plastic,
as an antimicrobial composition is medical instruments such as catheter, prosthesis, implants, etc.
as an antimicrobial additive in cleaning compositions or devices, disinfectants and toiletry, such as shampoo, soap, deodorant, mouthwash and toothpaste
as an antimicrobial additive in cosmetics,
as an antimicrobial additive for sterilization of solutions, such as drinking water,
as an antimicrobial composition in cesspools, sewers, swimming pools
as an antimicrobial additive in foodstuffs.

The composition of the invention can be applied to the product by coating, spraying, impregnating, brushing, spreading, wetting, etc. Food products can be protected, for example, by spreading the composition of the invention on the surface of foodstuff or by including the composition into a food product. If desired, the composition can be washed out from the food product before use.

The following examples are given for further illustration of the invention without limiting the invention thereto.

### EXAMPLES

### Example 1

10 g of purified solid coniferous resin in powdery form was dissolved in 100 ml of pure glycerol for 3 weeks. The resultant glycerol solution was diluted with saline to provide a 50% aqueous colloidal dispersion. The dispersion was then filtered. A clear dispersion was obtained as a stock solution that was further diluted with an aqueous medium without any formation of precipitations.

The amounts of various resin acids of the stock solution were analyzed by the GC/MS method. The amounts of resin acids are the mean values of three separate assays. In calculation of the quantities of resin acids, calibration was done against heptadecanoic acid and isopimaric acid standards.

The resin acids and contents thereof are disclosed in Table 1.

TABLE 1

| Dissolved resin acid | Content (mg/L) (ppm) |
|---|---|
| dehydroabietic acid | 0.70 |
| 7β-hydroxyabietic acid | 1.49 |
| 7α-hydroxydeabietic acid | 3.00 |
| 15-hydroxydehydroabietic acid | 12.08 |
| 7β,15-hydroxydehydroabietic acid | 5.43 |
| 7α,15-hydroxydehydroabietic acid | 15.30 |

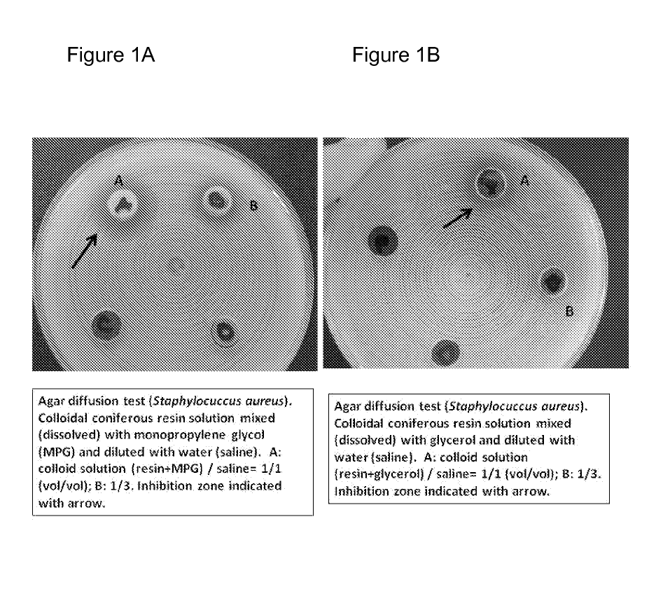

The stock solution was further diluted with a saline solution for the microbiological tests described below. FIG. 1B illustrates the antimicrobial characteristic of the composition where the stock solution is diluted in the ratio of 1:1 by volume and 1:3 by volume with a physiological saline solution. In Table 2, the stock solution is diluted with a physiological saline solution in the range of 1:1-1:100 by volume.

For example, the stock solution can be diluted to a 25% solution with a physiological saline solution and can be used, for example, as an antimicrobial injection agent for inflamed joint, such as knee joint, or as an antimicrobial injection or washing agent in body cavities or abscesses. The solution can contain further appropriate pharmaceutically active agent(s), such as cortisone or glucosamine.

### Example 2

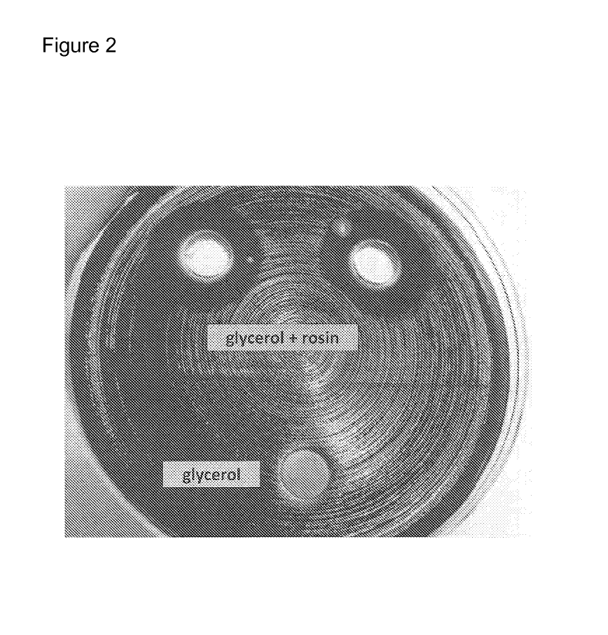

A stock solution was prepared as described in Example 1 except that rosin of industrial origin, that is for 90 s from Forchem Oy, having high content of abietic type rosin acids, was used instead of spruce callus resin. The antimicrobial effect of the stock solution is shown in Table 2 and FIG. 2.

The stock solution was further diluted with tap water in various ratios for the microbiological test described below. The results given in Table 3 are achieved with a solution where the stock solution is diluted with tap water in the ratio of 1:1 by volume. Table 4 shows the antimicrobial effect of the solutions with various dilutions.

Example 3

A stock solution was prepared as described in Example 1 except that pure monopropylene glycol (MPG) was used as dispersing agent. The stock solution was diluted with a physiological saline solution in the ratio of 1:1 by volume and 1:3 by volume for the microbiological tests described below (FIG. 1A).

The antimicrobial compositions can be blended with formulations suitable for use as an antimicrobial agent in the treatment of skin diseases, or as an antimicrobial additive in cosmetic products, soaps, shampoos or washing agent. The dispersion can also contain, for example, hydrocortisone, cortisone or dexpanthenol.

### Example 4

A stock solution was prepared as described in Example 1 except that xylitol was used as dispersing agent. The solution can be diluted with saline to provide an antimicrobial composition having 1 to 50 ppm of the resin acids. The composition can be used as mouthwash and as a solution for prevention and treatment of dental caries. The dispersion can be supplemented with therapeutically active agents and excipients, such as flavourings. The dispersion is applicable as an oral liquid formulation or as solid tablet where the composition is absorbed to a solid carrier (e.g. gelatin, agar) in the treatment of H. pylori infection.

### Example 5

Purified coniferous callus resin in powdery form was dissolved in an aqueous glycerol solution (70%) for several weeks to provide a dispersion. The dispersion was subsequently diluted with saline in the ratio of 1:2 by volume. The resultant solution is 25% with respect to glycerol. A precipitate of insoluble resin was formed and filtered off. A yellowish, clear, viscous solution was obtained. Its resin acid content is as described in Table 1 and the antimicrobial property as presented in Table 2.

### Example 6

Coniferous callus resin was dissolved in ethanol to provide a 65% solution. 40 ml of this ethanol solution was mixed for 1 day with 200 ml of pure glycerol to provide a mixture. The mixture was diluted with 240 ml of saline (1:1 by volume). A precipitation of insoluble resin acids was formed and removed by filtration. A colloidal dispersion was obtained as a filtrate. The filtrate was allowed to stand overnight at a room temperature to evaporate ethanol from the filtrate. The composition can be further diluted with an aqueous medium without precipitations.

### Example 7

Purified coniferous callus resin is dissolved in pure water for 2 hours. Microbiological challenge test in accordance with EN 13697 is performed. The solution showed no antimicrobial effect during 28 days against S. aureus, E. coli, Ps. aeruginosa, Ps. putida, Kl. pneumoniae, C. ablicans and Aspergillus niger. The example demonstrates that the using of a dispersion agent (e.g., glycerol) enhances the dissolvation of specific resin acids to water, resulting in as an antimicrobial dispersion composing of dispersion agent, water and specific water soluble resin acids in ppm quantity.

### Microbiological Tests

The antimicrobial effect of the compositions of the invention is illustrated in FIGS. 1-2 and Tables 2-4. In FIGS. 1-2, the antimicrobial effect was tested be means of a diffusion test. In this test, the antimicrobial composition of the invention as a test solution is set into small, e.g., 2 mm, wells drilled into the medium on the plate. When the test solution diffuses from wells into the culture medium on the plate, it prevents the growth of the bacteria if the solution is antimicrobial. The antimicrobial effect is seen as a visible inhibition zone (“halo”) of growth of bacteria around the well. The larger the inhibition zone is, the higher is the antimicrobial activity of the test solution.

In FIGS. 1A and 1B, the compositions of the invention prepared in Example 1 and 3, respectively, were tested against Staphylococcus aureus in the agar diffusion plate test, the microorganism being commonly used as a standard target in tests on antimicrobial influences. FIGS. 1A and 1B show that the compositions of the invention are antibacterial against the Staphylococcus aureus.

In FIG. 2, the composition of the invention prepared in Example 1 was tested against Helicobacter pylori in Brucella agar plate. FIG. 2 shows that the composition of the invention is clearly antimicrobial against the microorganism.

The antimicrobial effect of the compositions of the invention was also tested with a challenge test. The test was carried out in accordance with the European Pharmacopoeia microbiological challenge test (EN 13697). In the test, a specific number of test bacteria are inoculated into a specific volume of a solution tested for the antimicrobial property. After inoculation, samples are taken from the solution at specific time intervals and cultured in bacterium-specific media. By this setting, the antimicrobial activity of the solution can be calculated by indices of how much (how effectively) the test solution killed the inoculated bacteria in specific time unit. A reduction of the number of bacteria in colony forming unit more than 1×log 10 (4 logs) in 24 hours is considered to indicate a good antimicrobial activity.

In Table 2, the composition of the invention prepared in Examples 1 and 2 were tested against Staphylococcus aureus (MRSA strain). Test samples were analyzed after 24 hours incubation. The growth reduction of 1 indicates that the antimicrobial effect was poor. The growth reduction of >4 logs indicates a reduction of number of microorganisms by more than 1×10 log⁴ and means a good antimicrobial effect. The test showed that aqueous glycerol (70%) was not antimicrobial. The composition of the invention prepared in Example 1 was antimicrobial in saline dilutions up to 1:9. The composition of the invention prepared in Example 2 was also antimicrobial.

TABLE 2

| Composition | Dilution | MRSA growth reduction |
|---|---|---|
| Aqueous glycerol (70%) | | 1 |
| Glycerol + resin + saline | 50% stock | >4 log |
| (Example 1) | solution | |
| | 1:1 | >4 log |
| | 1:2 | >4 log |
| | 1:3 | >4 log |
| | 1:4 | >4 log |
| | 1:5 | >4 log |
| | 1:9 | >4 log |
| | 1:15 | 1 |
| | 1:100 | 1 |
| Glycerol + rosin + saline | 50% stock | >4 log |
| (Example 2) | solution | |

The antimicrobial effect of the compositions of the invention was also tested against Staphylococcus aureus in accordance with the ISO standard 20645/20743 challenge test in accordance with EN 13697 on a steel plate. The test was performed after one week washing the steel plate with the composition. Test samples were analyzed after 24 hours incubation. The antimicrobial effect of the composition prepared in Example 2 is shown in Table 3 and 4.

TABLE 3
Reduction in growth of microorganisms

| | | | PS. ae- | | | C. |
|---|---|---|---|---|---|---|
| | MRSA* | Enteroc. | rug. | E. coli | A. niger | albicans |
| Plate | log 1 | log 1 | log 1 | log 1 | log 1 | log 1 |
| (ref.) | | | | | | |
| Plate | log 1 | log 1 | log 1 | log 1 | log 1 | log 1 |
| washed | | | | | | |
| with 70% | | | | | | |
| ethanol | | | | | | |
| Plate | >log 3 | >log 3 | >log 3 | >log 3 | >log 3 | >log 3 |
| washed | | | | | | |
| with com- | | | | | | |
| position of | | | | | | |
| Example 2 | | | | | | |

*Staphylococcus aureus

The results show that the 70% ethanol exhibits no antimicrobial effect whereas the composition of Example 2 exhibits good antimicrobial effect.

TABLE 4
Reduction in growth of staphylococcus aureus

| Composition | Dilution | Growth reduction |
|---|---|---|
| 100% glycerol | | 1 |
| | 1:1 | 1 |
| | 1:3 | 1 |
| | 1:9 | 1 |
| | 1:16 | 1 |
| | 1:33 | 1 |
| Example 2 | 50% stock | >log 4 |
| | solution | |
| | 1:1 | >log 4 |
| | 1:3 | >log 4 |
| | 1:9 | >log 4 |
| | 1:16 | <log 4 |
| | 1:33 | <log 4 |

The results show that the 100% glycerol exhibits no antimicrobial effect whereas the composition of Example 2 exhibits good antimicrobial effect.

It will be obvious to a person skilled in the art that, as the technology advances, the inventive concept can be implemented in various ways. The invention and its embodiments are not limited to the examples described above but may vary within the scope of the claims.

1-33. (canceled)

34. An aqueous antimicrobial composition comprising coniferous resin acids, a dispersing agent and an aqueous medium, wherein an amount of the coniferous resin acids of the composition is in the range of about 1 to about 100 ppm, the coniferous resin acids being selected from resin of coniferous trees and resin acid fraction of tall oil obtained from kraft pulping of coniferous trees, and the dispersing agent being selected from a group consisting of polyhydric alicyclic alcohol, polyhydric aliphatic alcohol, dimethyl sulfoxide, acetone, protein-containing aqueous liquid, sugar-containing aqueous liquids, serum, plasma, liquid used in cell and tissue cultures and a mixture thereof.

35. The composition of claim 34, wherein the amount of the coniferous resin acids of the composition is about 1 to about 50 ppm, more preferably about 1 to about 10 ppm.

36. The composition of claim 34, wherein the coniferous resin acids comprise dehydroabietic acid, 7β-hydroxydehydroabietic acid, 7α-hydroxydehydroabietic acid, 15-hydroxydehydroabietic acid, 7β,15-dihydroxydehydroabietic acid, 7α,15-dihydroxydehydroabietic acid, 18-hydroxydehydroabietic acid, further hydroxylated derivates of dehydroabietic acid or a mixture thereof.

37. The composition of claim 34, wherein the polyhydric aliphatic alcohol is selected from a group consisting of glycerol, monopropylene glycol, xylitol, mannitol and sorbitol.

38. The composition of claim 34, wherein the dispersing agent is glycerol.

39. The composition of claim 34, wherein the aqueous medium is water or a physiological saline solution.

40. A pharmaceutical formulation comprising an aqueous antimicrobial anti-inflammatory composition of claim 34 and pharmaceutically acceptable diluent, carrier and/or excipient.

41. The pharmaceutical formulation of claim 40, wherein the formulation is a tablet, capsule, solution, infusion or injection liquid, clysma (enema), washing agent, drop, spray, salve, ointment, lotion, lacquer, enema, vagitorioum or suppositorium.

42. The pharmaceutical formulation of claim 40, wherein the formulation is administered orally, intravenously, intra-arterially, subcutaneously, intramuscularly, topically, as an injection or as an injection.

53. A method for producing an aqueous antimicrobial composition of claim 34, comprising the steps of:
providing coniferous resin acids,
dissolving the resin acids in a dispersing agent,
diluting the mixture with an aqueous medium to provide an aqueous antimicrobial composition.

44. The method of claim 43, wherein the dissolution is performed under stirring and/or heating.

45. The method of claim 43, wherein the aqueous antimicrobial composition is filtered.

46. A method of treating inflammation and/or infection in a mammal, comprising administering a therapeutically effective amount of an aqueous antimicrobial composition of claim 34 or a pharmaceutical formulation comprising the aqueous antimicrobial composition and pharmaceutically acceptable diluent, carrier and/or excipient.

47. The method of claim 46, wherein the inflammation and/or infection is caused by Helicobacter pylori.

48. A method of using an aqueous antimicrobial composition of claim 34, wherein the aqueous composition is introduced as an antimicrobial agent into industrial materials and products.

49. The method of claim 48, wherein the industrial material is paper, paperboard, cardboard, leather, textile, fiber, fur, rubber, wood, glass, metal, concrete or plastic.

50. The method of claim 48, wherein the composition is applied to the material by coating, spraying, impregnating, brushing, spreading or wetting.

51. The method of claim 48, wherein the product is a paint, varnish, wax, fiber, coating, cleaning agent, preserving agent, disinfectant, toiletry, such as shampoo, soap, deodorant, toothpaste and mouthwash, wood protective agent, medical textile, such as cloth and bandage, medical instruments, such as catheter, prosthesis, implant.

52. A method of sterilizing of water, water reservoirs, swimming pools, sewers, wherein an aqueous antimicrobial composition of claim 34 is introduced as an antimicrobial agent to water, water reservoirs, swimming pools, sewers.

53. Foodstuffs comprising an aqueous antimicrobial composition of claim 34 as a preservative or an antimicrobial agent.

54. A biocide comprising an aqueous antimicrobial composition of claim 34.
